(19) United States
(12) Patent Application Publication
(10) Pub. No.: US 2009/0007931 A1
(43) Pub. Date: Jan. 8, 2009

(54) Method And Device For Drying A Flow Of Biomass Particles

(75) Inventors: Niels Krebs, Hellerup (DK); Sten Dueholm, Hellerup (DK)

Correspondence Address: DAY PITNEY LLP, 7 TIMES SQUARE, NEW YORK, NY, 10036-7311, US

(73) Assignees: FORCE TECHNOLOGY, Brondby (DK); WESSER OG DUEHOLM ARKITEKT-OG INGENIORFIRMA V/STEN DUEHOLM, Hellerup (DK)

(21) Appl. No.: 11/665,897

(22) PCT Filed: Oct. 24, 2005
(86) PCT No.: PCT/DK2005/000685

§ 371 Date: Apr. 17, 2008

(30) Foreign Application Priority Data
Oct. 22, 2004 (DK) PA 2004 01623

(51) Int. Cl. F26B 5/02; F26B 3/04; F26B 17/00

(52) U.S. Cl. 134/1; 34/443; 34/60

(57) ABSTRACT

A method and a system to be used in the process of manufacturing plates, such as fibreboards, particleboards and the like boards, where the raw material in the form of biomass particles, such as wood fibres or wood particles of various size and shape are dried from its natural moisture content to a moisture content suitable to be applied with a thermosetting binder and be spread onto a movable forming belt to form a mat, and where said mat by means of a hot press is compressed into the desired thickness of the finished plate and the thermosetting binder is hardened. According to the invention, the drying process of the biomass particles is facilitated by the use of ultrasound to remove the sub-layer of air at the surface of the particles and thus to intensify the transport of heat energy into the particles and the transport of moisture from the particles.

### FIELD OF THE INVENTION

The invention relates to a system for drying a flow of biomass particles. The invention further relates to a method of drying a flow of biomass particles.

### BACKGROUND OF THE INVENTION

In traditional manufacturing of biomass-based plates, panels or boards, in the wood industry usually called particleboards, MDF-boards (Medium Density Fibreboards) and OSB (Oriented Strand Boards), the raw material in the shape of wood or biomass particles, fibres or larger particles (strands) are dried from its natural moisture content, usually in the range of 80-120% of water in relation to dry matter of material, to a moisture content suitable for the subsequent process of application of binder, forming and hot pressing, in a convection drying process using a flow of hot air or hot steam to apply heat energy to the material and to remove the evaporated moisture in the form of water vapour from the surface of the material.

The efficiency of the process of drying wood or similar materials by means of convection, i.e. hot gaseous drying medium streaming along the surface of the material, is determined by the character of the flow which can be laminar or turbulent.

For the drying of biomass particles as a part of the processes of manufacturing biomass-based panels a large variety of machinery has been used. During the last 2 decades, however, 2 basic principles have become predominant, depending on the type and size of the biomass particles:

Large particles such as strands for OSB (Oriented Strand Boards) or particles for conventional particleboards are usually dried in horizontal drum driers, rotating to mix particles and the hot drying medium and to move the particles furnish from the inlet end to the outlet end of the drum.

As a drying medium hot gas from combustion of oil, gas or wood residuals (direct heating) or hot air from a heat exchanger (indirect heating) is used.

Smaller particles such as fibres for MDF (Medium Density Fibreboards) are usually dried in a flash dryer, i.e. a tube-shaped duct in which an airborne flow of fibres are dried using said direct or indirect heating of the air as a drying medium.

An exception is a technique of fibre drying using superheated steam as a drying medium in the flash dryer, see e.g. WO 96/34726 where a process for producing fireboard from wood fibres is disclosed where hot steam used in the flash dryer duct for drying and transportation of the saturated steam/fibre mixture.

In the process of manufacturing MDF (Medium Density Fibreboards), the binder is usually added to the fibre flow in the so-called blow-line before the dryer. Consequently, the temperature in the flash dryer is limited to around 200° C. at the inlet and 60-70° C. at the outlet of the dryer to avoid pre-curing and thus the loss of binding ability of the binder during the subsequent hot pressing of the fibre mat.

Alternatively, other techniques to add the binder to the fibre after drying (see e.g. Danish patent application PA 2004 01297 allow for a more efficient drying of the fibres at higher temperatures, i.e. at an inlet temperature of 300-350° C. and an outlet temperature of 140-160° C. while avoiding pre-curing of the binder.

However, independently of the type of dryer and thermal conditions in relation hereto, a basic condition will always command and limit the efficiency of the drying process: namely the energy and mass (moisture) exchange at the surface of the biomass particles (i.e. heat in, moisture out).

The energy and mass exchange at the surface of the biomass particles is largely determined by the character of the gas flow and more specifically by the character or presence of the so-called laminar sub-layer. Heat transport across the laminar sub layer will be by conduction or radiation, due to the nature of laminar flow while mass transport across the laminar sub layer will be solely by diffusion.

The main components of biomass particles are cellulose, hemicellulose and lignin. Due to free OH-groups at the surface of the biomass, biomass-particles tend to attract each other, when the distance between the particles is reduced to the range of the attractive forces between the OH-groups (van der Waal-forces).

Within the traditional process of fibreboard manufacturing in a so-called wet process the attraction between biomass-particles is utilised to establish bonding between the fibres without the use of an additional binder.

In modern manufacturing of fibreboards, usually called Medium Density Fibreboards (MDF), in a dry process, where the bonding of the fibres is established by adding a synthetic binder, the natural attraction between the fibres due to the van der Waal-forces is highly disadvantaguous.

The fibres, usually transported in an airborne flow while drying and application of binder, tend to lump together and thus become less available to both the drying gaseous medium and the application of binder.

In typical well-known MDF-processes large volumes of process air and high airflow velocities are used to establish turbulent flow with the aim to split the fibre lumps in the drying and binder application process.

In terms of energy consumption this approach is very costly and in terms of singularising the fibres it is not very efficient.

Furthermore transporting the fibres in an airborne flow while drying does not guarantee an efficient process even in a high velocity, turbulent airflow. The fibres follow the air flow with approximately the same velocity and only a very low air velocity is obtained at the surface of the fibres and, consequently, the exchange of energy and moisture (heat energy in, water vapour out) at the surface of the fibres is very inefficient.

All above disadvantages of the traditional process apply to the MDF manufacturing process.

Patent specification JP 7055339 A discloses a drying device where air being supplied by a fan is brought into contact with 3 rod-like heaters and then through an ultrasound nozzle. This drying device is for removing water from a water-washed running member. The ultrasound sound pressure and drying capacity of JP 7055339 A has due to the specific arrangement a maximum effect that does not make it suitable for drying an airborne flow of wet biomass particles.

Patent specifications CH 676 879 A5 and WO 89/12207 discloses a process and device for drying a particulate material where batch freezing of a particulate material is formed by freezing droplets from a spray of solution in suspension in a fluidized bed. The material to be freeze-dried is introduced into a chamber together with air and an appropriate freezing agent.

A pneumatic sound emitter produces sound with frequencies that may be in the upper hearable frequency spectrum or in the ultrasound sound frequency spectrum. The ultrasound may be produced according to the so-called Galton whistle principle. Such a Galton whistle is typically capable of producing ultrasound with a sound pressure level at the exit of the whistle of about 120-128 dB.

Also known (not mentioned in patent specification CH 676 879 A5/WO 89/12207) are a so-called modified Galton whistle typically capable of 128-132 dB and a so-called Vonnegut (vortex) whistle capable of a sound pressure level of approximately 120-128 dB.

The generated sound is introduced into the freeze-drying chamber via a membrane. The gaseous medium driving the sound emitter is not introduced into the chamber but is kept separate.

The disclosed static batch drying uses freeze-drying in order to obtain drying with a satisfactory properties the material being dried. The application of a freezing agent hinders the efficiency of the drying process as (heat)energy is removed from the process due to the presence of the freezing agent.

Patent specifications U.S. Pat. No. 4,043,049 A, U.S. Pat. No. 3,808,093 A, and U.S. Pat. No. 5,295,310 A discloses various systems for (flash) drying an airborne flow of pulp. U.S. Pat. No. 5,295,310 A discloses drying of material where the material is supplied into a first drying conduit where it is dried and transported to a first cyclone by means of the drying air. The material is separated from the drying air in the first cyclone and the separated material is supplied into a second drying conduit where it is dried and transported to a second cyclone by means of the drying air where it again is separated from the drying air. The drying air from the first cyclone is condensed to be discharged in the form of water containing fibre dust, formaldehyde, and hydrocarbons to a water-purifying apparatus. This removes emissions of pollutants. Patent specification U.S. Pat. No. 4,043,049 A and U.S. Pat. No. 3,808,093 A discloses other conventional flash-dryers.

### OBJECT AND SUMMARY OF THE INVENTION

It is an object of the present invention to provide a system (and a corresponding method) for drying a flow of biomass particles that solves (among other things) the above-mentioned shortcomings of prior art.

It is a further object to provide a method and system enabling efficient drying of a flow of biomass particles using a gaseous drying medium.

It is yet another object of the present invention to provide an efficient drying of biomass particles using less energy than required by traditional processes.

Another object is to provide drying of biomass particles enabling acceleration of the drying process compared to traditional processes.

These objects (among others) are solved by a system for drying a flow of biomass particles, the system comprising: a dryer adapted to receive a flow of wet biomass particles and to dry the flow of wet biomass particles using a gaseous drying medium, wherein the dryer comprises at least one ultrasound device or is in connection with at least one ultrasound device, where said at least one ultrasound device is adapted, during use, to supply at least a part of said gaseous drying medium to said flow of biomass particles and where said at least one ultrasound device, during use, removes or minimizes a laminar sub-layer being present at the surface of said wet biomass particles.

In this way, a more efficient drying of the biomass particles is obtained, which results in a significant reduction in drying time and power consumption of the dryer. The reason is that the ultrasound minimizes or eliminates the laminar sub-layer, as described elsewhere, where the absence of the sub-layer enables a much enhanced heat and moisture exchange.

The application of ultrasound intensifies very efficiently the energy and mass exchange at the surface of the biomass particles and thus helps to reduce the drying time of the biomass particles, to reduce the volume of the dryer vessel, to reduce the surplus volume of drying medium needed to establish heat and mass transfer at the surface of the biomass particles under non-optimal conditions, and to improve the thermal efficiency of the process significantly.

High intensive sound or ultrasound in gases leads to very high velocities and displacements of the gas molecules. For example, 160 dB corresponds to a particle velocity of 4.5 m/s and a displacement of 33 μm at 22.000 Hz. In other words, the kinetic energy of the molecules has been increased significantly.

Further, the application of ultrasound to fibres will split up the lumps of fibre very efficiently. Even when using smaller volumes of air. Further, the fibres will receive an electro-static charge during the process that very efficiently keeps them from ‘lumping up’ together again. Further, the electro-static charge will cause the micro-structures (microfibrils) of the separated and torn-up fibers to stand up, which greatly increases the surface of the fibres, which further increases the efficiency of the drying of them and the binder-application to them.

In a preferred embodiment, the at least one ultrasound device is activated by at least a part of the gaseous drying medium.

In this way, the large amount of energy typically present in such systems is utilized in generating ultrasound with a high effect and sound pressure level. Further, since the gaseous drying medium is present in traditional systems already less modifications are needed for modifying traditional system into applying the present invention.

In one embodiment, the gaseous drying medium is hot air or superheated steam.

In one embodiment, the system further comprises binder application means for applying a binder solution comprising binder droplets to the flow of biomass particles wherein the binder application means comprises at least one ultrasound device adapted, during use, to apply ultrasound to the flow of biomass particles
before the binder solution is applied whereby particle lumps, if any, in the flow of biomass particles are separated, or
substantially at the same time that the binder solution is applied whereby particle lumps, if any, in the flow of biomass particles are separated and binder droplets are reduced to a smaller size.

In one embodiment, the system further comprises binder application means for applying a binder solution to said flow of biomass particles before they are received in said dryer.

In one embodiment, the system further comprises a forming station adapted to receive a flow of biomass particles applied with binder droplets after application of ultrasound by said at least one ultrasound device and to produce a mat from said flow of biomass particles applied with binder droplets, and a hot press adapted to receive a mat from said forming station and to produce a plate, such as a MDF (Medium Density Fibreboard) or the like, from said mat.

In one embodiment, the ultrasound device comprises: an outer part and an inner part defining a passage, an opening, and a cavity provided in the inner part, where said ultrasound device is adapted to receive a pressurized gas and pass the pressurized gas to said opening, from which the pressurized gas is discharged in a jet towards the cavity.

In one embodiment, the flow of biomass particles is an airborne flow of fibres.

In one embodiment, the flow of biomass particles is a mechanically activated flow of larger biomass particles such as particles for traditional particleboards or strands for OSB (Oriented Strand Boards) or similar biomass-based products.

In one embodiment, the dryer comprises a plurality of ultrasound devices for supplying at least a part of said gaseous medium.

In one embodiment, the at least one of said at least one ultrasound devices generates ultrasound at a sound pressure selected from the group of:
approximately 135 dB or higher,
approximately 140 dB or higher,
approximately 150 dB or higher,
approximately 160 dB or higher.

The present invention also relates to a method of drying a flow of biomass particles, the method comprising the step of: drying a received flow of wet biomass particles using a gaseous drying medium, wherein the step of drying comprises supplying at least a part of said gaseous drying medium to said flow of biomass particles using at least one ultrasound device, where said at least one ultrasound device, during use, removes or minimizes a laminar sub-layer being present at the surface of said wet biomass particles.

The method and embodiments thereof correspond to the device and embodiments thereof and have the same advantages for the same reasons.

Advantageous embodiments of the method according to the present invention are defined in the sub-claims and described in detail in the following.

### BRIEF DESCRIPTION OF THE DRAWINGS

These and other aspects of the invention will be apparent from and elucidated with reference to the illustrative embodiments shown in the drawings, in which:

FIG. 1 schematically illustrates a block diagram of one embodiment of a system/method of the present invention;

FIG. 2a schematically illustrates a (turbulent) flow over a surface of an object according to prior art, i.e. when no ultrasound is applied;

FIG. 2b schematically shows a flow over a surface of an object according to the present invention, where the effect of applying high intensity sound or ultrasound to/in air/gas surrounding or contacting a surface of an object is illustrated;

FIG. 3a schematically illustrates a preferred embodiment of a device for generating high intensity sound or ultrasound.

FIG. 3b shows an embodiment of an ultrasound device in form of a disc-shaped disc jet;

FIG. 3c is a sectional view along the diameter of the ultrasound device (301) in FIG. 3b illustrating the shape of the opening (302), the gas passage (303) and the cavity (304) more clearly;

FIG. 3d illustrates an alternative embodiment of a ultrasound device, which is shaped as an elongated body;

FIG. 3e shows an ultrasound device of the same type as in FIG. 3d but shaped as a closed curve;

FIG. 3f shows an ultrasound device of the same type as in FIG. 3d but shaped as an open curve;

FIG. 4 schematically illustrates a part of the system where ultrasound is applied according to one embodiment of the present invention.

### DESCRIPTION OF PREFERRED EMBODIMENTS

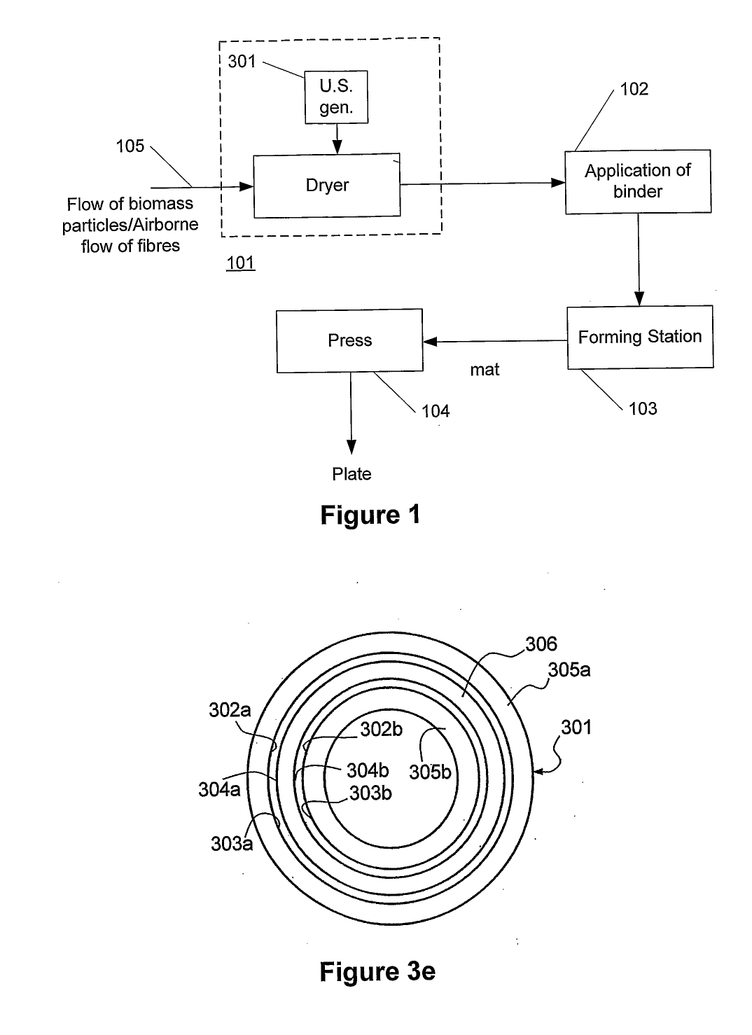

FIG. 1 schematically illustrates a block diagram of one embodiment of a system/method of the present invention. Illustrated is a dry fibreboard production line, i.e. a process of manufacturing plates such as MDF (Medium Density Fibreboards) or the like, where a synthetic binder is applied to biomass particles such as wood fibres or the like.

The process preferably involves an airborne flow of fibres (105) that is fed into a dryer (101) according to the present invention that dries the fibres to a moisture content of 1-20% or preferably 1-10% of dry matter, as explained in greater detail in the following.

According to the present invention, the dryer (101) comprises one or more ultrasound generators (301). In this way, a more efficient drying of the fibres is obtained, which result in a significant acceleration of the drying process. The reason is that the ultrasound minimizes or eliminates the laminar sub-layer, as described below, where the absence of the sub-layer enables a much enhanced heat exchange.

The ultrasound is carried by the gas and therefore giving the gas-molecules a very high kinetic energy. The distance between gas-molecules moving in one direction and having the maximal velocity and gas-molecules moving the opposite direction is given by half the wavelength of the ultrasound. The resulting effect is a very efficient drying of the fibres.

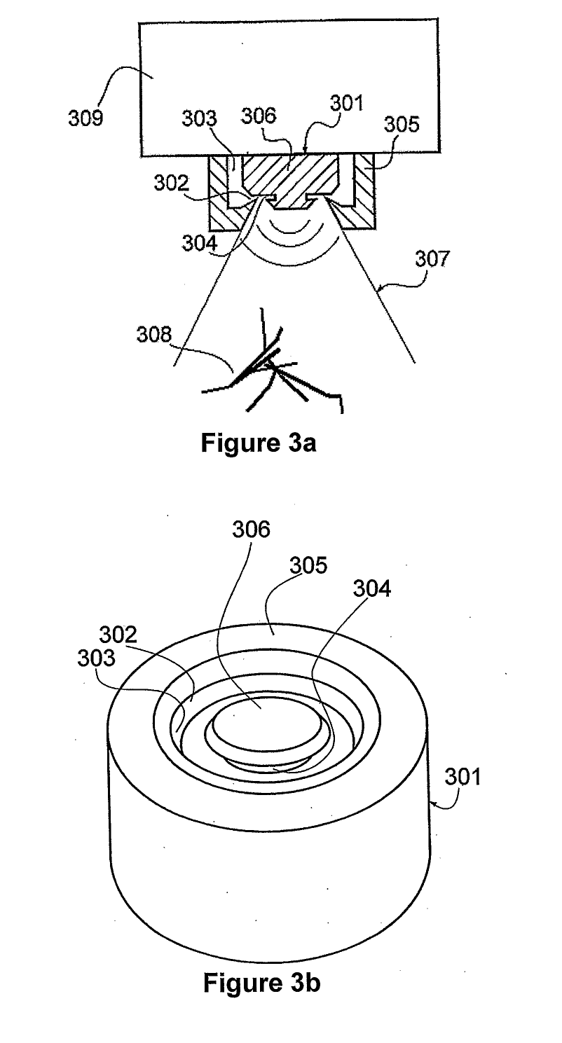

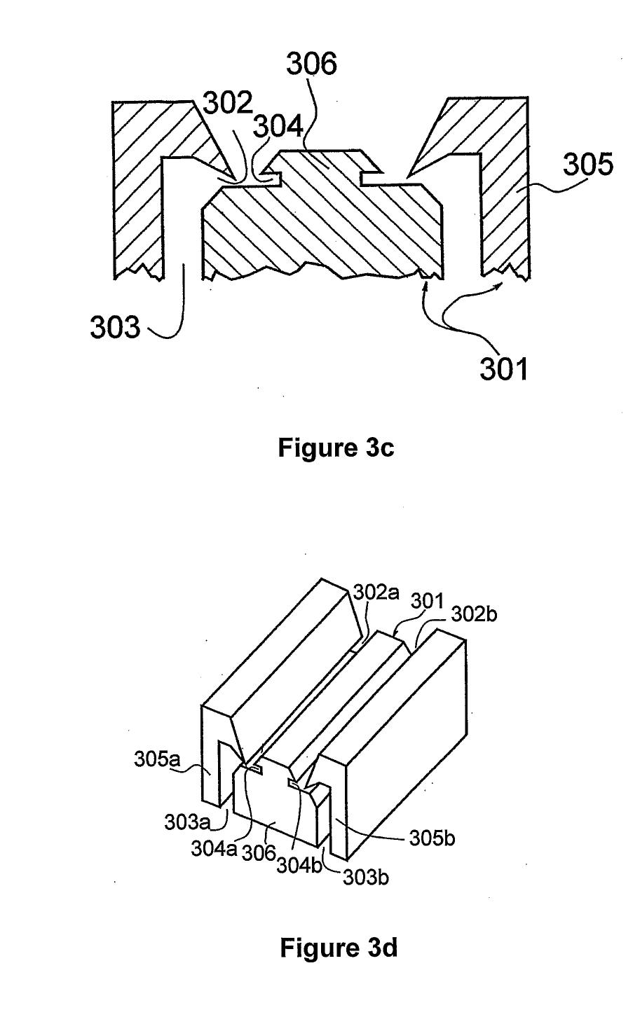

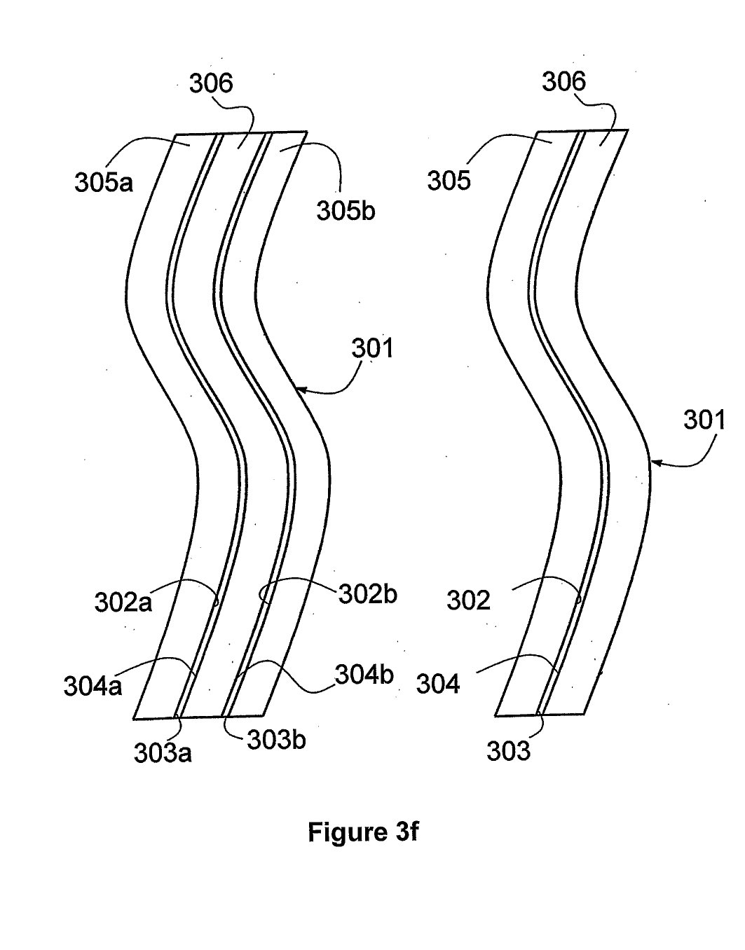

Many types of ultrasound generators are suitable for this and one preferred well known ultrasound generator is explained in connection with FIGS. 3a-3f.

The exchange of energy and moisture between the particles and the atmosphere is governed by the conditions as summarized below.

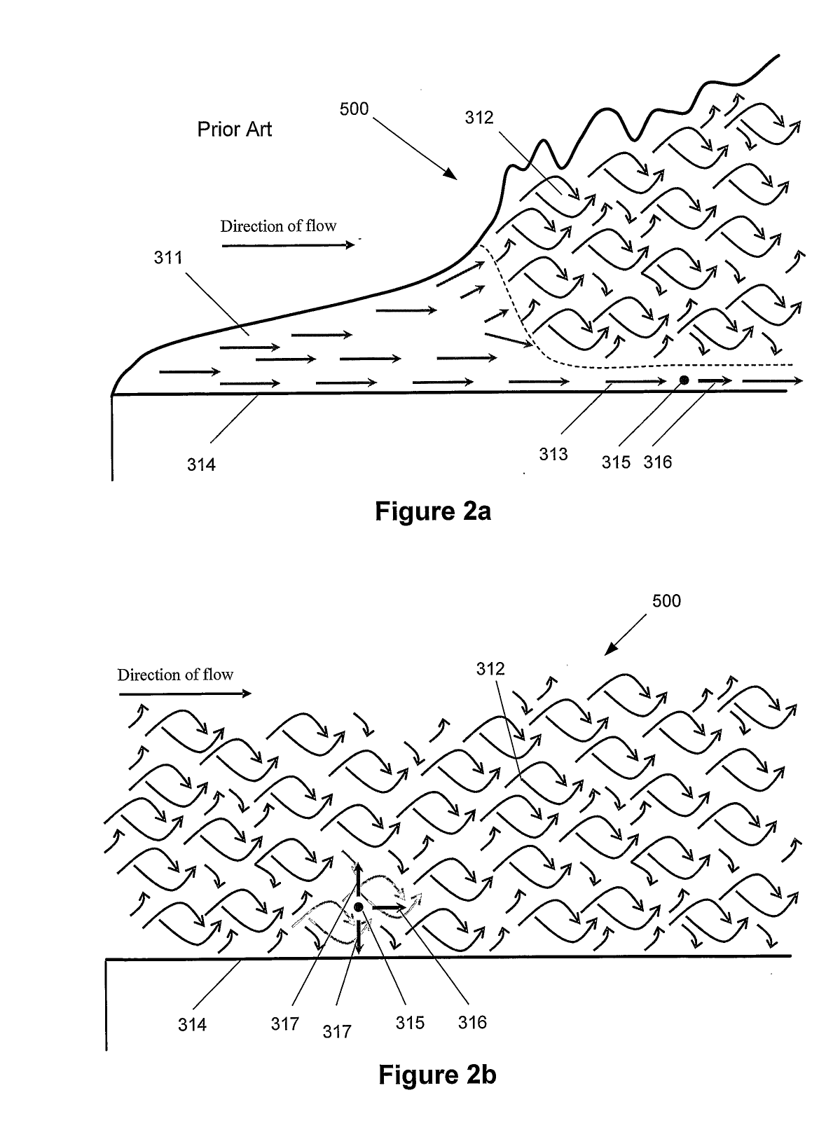

For nearly all practically occurring gas flows, the flow regime will be turbulent in the entirety of the flow volume, except for a layer covering all surfaces wherein the flow regime is laminar (see e.g. 313 in FIG. 2a). This layer is often called the laminar sub layer. The thickness of this layer is a decreasing function of the Reynolds number of the flow, i.e. at high flow velocities, the thickness of the laminar sub layer will decrease.

Heat transport across the laminar sub layer will be by conduction or radiation, due to the nature of laminar flow.

Mass transport across the laminar sub layer will be solely by diffusion.

Decreasing the thickness of the laminar layer will typically enhance heat and mass transport significantly.

This will be the case when high-intensive sound, preferably ultrasound is applied to the surface. The high-intensity ultrasound increases the interaction between the gas molecules and the surface and thus the heat transfer by passive or active convection at the surface.

Reducing/minimizing the laminar sub-layer provides increased heat transfer efficiency due to reduction of laminar sub layer and increased diffusion speed.

In a preferred embodiment, a pressurized gas like atmospheric air or superheated steam with a pressure of about 4 atmospheres is used to activate the at least one ultrasound device.

Depending on the drying equipment, the drying medium is pressurized and preferably hot air or superheated steam where only a part of the volume of drying medium is used to activate the at least one ultrasound device, Using the total amount of drying gaseous medium to active the at least one ultrasound device is another alternative.

The application of ultrasound intensifies very efficiently the energy and mass exchange at the surface of the biomass particles and thus helps to reduce the drying time of the biomass particles, to reduce the volume of the dryer vessel, to reduce the surplus volume of drying medium needed to establish heat and mass transfer at the surface of the biomass particles under non-optimal conditions, and to improve the thermal efficiency of the process significantly.

Additionally, the energy of the pressurized gas is in a first step transformed into high intensity ultrasound, is in a next step transformed into kinetic energy in the biomass particles, and is finally transformed into heat energy in the biomass particles. Thus, the application of ultrasound contributes significantly to the energy transfer independently of the flow conditions in the drying equipment.

After the fibres in the airflow have been dried they are to be applied with a suitable binder. The (synthetic) binder is applied by means for applying a binder solution (102), preferably, but not exclusively, as an aqueous solution onto the fibres in the airborne flow. After the fibres have been dried, the fibre flow usually consists of agglomerated fibre lumps, which as explained above is not desirable.

In a preferred embodiment, the ultrasound device(s) is/are activated by at least a part of the gaseous drying medium. In this way, the large amount of energy typically present in such systems is utilized in generating ultrasound with a high effect and sound pressure level. Further, since the gaseous drying medium is present in traditional systems already less modifications are needed for modifying traditional system into applying the present invention.

Alternatively, a process of producing fibreboards may comprise a conventional mechanical blender to apply binder to the dry fibres instead of an airborne process. In such a system, a more efficient mixing is obtained if one or more ultrasound devices are used in the mechanical blender.

As an alternative to the application of binder to the fibres after drying, binder may be added to the wet fibres prior to drying in which situation the application of high intensity ultrasound in the drying process has the same effect as described above.

According to an embodiment of the present invention, ultrasound is applied to the fibres by at least one suitable ultrasound generator, e.g. similar to the ultrasound generator(s) (301) used in connection with the dryer (101) according to the present invention, at substantially the same time as or before the application of binder to the fibre flow as disclosed in Danish patent application PA 2004 01297, incorporated herein by reference, by the same applicant. In this way, the agglomerated fibre lumps are transformed into a homogeneous flow of single fibres using ultrasound from one or more ultrasound devices driven by pressurized air, steam or another pressurized gas.

The generated high intensive ultrasound in a gas leads to very high velocities and displacements of the gas molecules, which in a very efficient way separate fibre lumps into single fibres. As mentioned, a homogenous flow of fibres with no or little lumps enable a more efficient distribution of the applied binder.

Further if the ultrasound is applied to the area where binder is sprayed into the fibre flow the binder droplets are also reduced to a smaller size due to the high intensity of the ultrasound. The smaller size of the droplets enables a very effective distribution and establishing of contact between binder droplets and fibres reducing the required amount of binder even further. See e.g. Danish patent application PA 2004 01297 for a more detailed description of this.

The aqueous binder solution is preferably sprayed into the airborne flow of fibres (102) by conventional means such as airless techniques.

The resulting mix of fibers and binder droplets is then fed to a forming station (103), which produces a fibre mat that finally is fed into a hot press (104) to press the mat to the desired thickness of the finished fibreboard and to cure the thermosetting binder. Such forming stations (103) and hot presses (104) are readily known in the art.

If needed, further measures preventing binder and fibres to stick to the walls of the device can be made by known conventional means such as cooling the walls of the device to a temperature below the dew point temperature in the device or by a state of the art method of heating the binder solution to a temperature of preferably 50-70° C. in order to reduce the water content of the binder solution and, at the same time, maintaining a sufficiently low viscosity in relation to the spraying equipment.

In some situations, if higher moisture content and temperature in the fibre furnish is needed, a part of the ultrasound device in the binder application can be driven by steam.

In this way, control of fibre and binder distribution as well as moisture and temperature of the fibre furnish is easily obtainable.

The main components of biomass particles are cellulose, hemicellulose and lignin. Due to free OH-groups at the surface of the biomass, biomass-particles tend to attract each other, when the distance between the particles is reduced to the range of the attractive forces between the OH-groups (van der Waal-forces).

Within the traditional process of fibreboard manufacturing in a so-called wet process the attraction between biomass-particles is utilised to establish bonding between the fibres without the use of an additional binder.

In modern manufacturing of fibreboards, usually called Medium Density Fibreboards (MDF), in a dry process, where the bonding of the fibres is established by adding a synthetic binder, the natural attraction between the fibres due to the van der Waal-forces is highly disadvantaguous.

The fibres, usually transported in an airborne flow while drying and application of binder, tend to lump together and thus become less available to both the drying gaseous medium and the application of binder.

In typical well-known MDF-processes large volumes of process air and high airflow velocities are used to establish turbulent flow with the aim to split the fibre lumps in the drying and binder application process.

In terms of energy consumption this approach is very costly and in terms of singularising the fibres it is not very efficient.

Furthermore transporting the fibres in an airborne flow while drying does not guarantee an efficient process even in a high velocity, turbulent airflow. The fibres follow the air flow with approximately the same velocity and only a very low air velocity is obtained at the surface of the fibres and, consequently, the exchange of energy and moisture (heat energy in, water vapour out) at the surface of the fibres is very inefficient.

All above disadvantages of the traditional process apply to the MDF manufacturing process.

In the process of manufacturing products of larger biomass particles (particleboards and Oriented Strand Boards—OSB), the attraction between particles and the tendency of building up lumps in the drying and binder application process is of minor importance.

Improvements of the poor efficiency of drying by means of a hot gaseous medium is still a very important issue for these processes.

The application of ultrasound to fibres will split up the lumps of fibre very efficiently. Even when using smaller volumes of air. Further, the fibres will receive an electro-static charge during the process that very efficiently keeps them from ‘lumping up’ together again. Further, the electro-static charge will cause the micro-structures of the separated and torn-up fibers to stand up, which greatly increases the surface of the fibres, which further increases the drying of them and the binder-application to them.

FIG. 2a schematically illustrates a (turbulent) flow over a surface of an object according to prior art, i.e. when no ultrasound is applied. Shown is a surface (314) of an object with a gas (500) surrounding or contacting the surface (314). As mentioned, thermal energy can be transported through a gas by conduction and also by movement of the gas from one region to another. This process of heat transfer associated with gas movement is called convection. With a condition of forced convection there will be a laminar boundary layer (311) near to the surface (314). The thickness of this layer is a decreasing function of the Reynolds number of the flow, so that at high flow velocities, the thickness of the laminar boundary layer (311) will decrease. When the flow becomes turbulent the layer are divided into a turbulent boundary layer (312) and a laminar sub-layer (313). For nearly all practically occurring gas flows, the flow regime will be turbulent in the entirety of the streaming volume, except for the laminar sub-layer (313) covering the surface (314) wherein the flow regime is laminar. Considering a gas molecule or a particle (315) in the laminar sub-layer (313), the velocity (316) will be substantially parallel to the surface (314) and equal to the velocity of the laminar sub-layer (313). Heat transport across the laminar sub-layer will be by conduction or radiation, due to the nature of laminar flow. Mass transport across the laminar sub-layer will be solely by diffusion. The presence of the laminar sub-layer (313) does not provide optimal or efficient heat transfer or increased mass transport. Any mass transport across the sub-layer has to be by diffusion, and therefore often be the final limiting factor in an overall mass transport. This limits the efficiency of drying of the fibres. Decreasing the thickness of this laminar sub-layer will typically enhance heat and mass transport significantly, i.e. provide a more efficient drying as explained above and in the following.

FIG. 2b schematically shows a flow over a surface of an object according to the present invention, where the effect of applying high intensity sound or ultrasound to/in air/gas (500) surrounding or contacting a surface of an object is illustrated. More specifically, FIG. 3b illustrates the conditions when a surface (314) of a fibre is applied with high intensity sound or ultrasound. Again consider a gas molecule/particle (315) in the laminar layer; the velocity (316) will be substantially parallel to the surface (314) and equal to the velocity of the laminar layer prior applying ultrasound. In the direction of the emitted sound field to the surface (314) in FIG. 2b, the oscillating velocity of the molecule (315) has been increased significantly as indicated by arrows (317). As an example, a maximum velocity of v=4.5 m/sec and a displacement of +/−33 μm will be achieved where the ultrasound frequency f=22 kHz and the sound intensity=160 dB. The corresponding (vertical) displacement in FIG. 2b is substantially 0 since the molecule follows the laminar air stream along the surface. In result, the ultrasound will establish a forced heat flow from the surface to surrounding gas/air (500) by increasing the conduction by minimizing the laminar sub-layer. The sound intensity is in one embodiment 135 dB or larger. In another embodiment, the sound intensity is 140 dB or larger. In yet another embodiment the sound intensity is 150 dB or larger. Preferably, the sound intensity is selected from the range of approximately 140-160 dB. The sound intensity may be above 160 dB.

The minimization of the laminar sub-layer has the effect that the mass transport between the surface of the fibre and the gas is increased resulting in more efficient heating.

FIG. 3a schematically illustrates a preferred embodiment of a device (301) for generating high intensity sound or ultrasound. Pressurized gas is passed from a tube or chamber (309) through a passage (303) defined by the outer part (305) and the inner part (306) to an opening (302), from which the gas is discharged in a jet towards a cavity (304) provided in the inner part (306). If the gas pressure is sufficiently high then oscillations are generated in the gas fed to the cavity (304) at a frequency defined by the dimensions of the cavity (304) and the opening (302). An ultrasound device of the type shown in FIG. 3a is able to generate ultrasound acoustic pressure of up to 160 dB_{SPL} at a gas pressure of about 4 atmospheres. The ultrasound device may e.g. be made from brass, aluminum or stainless steel or in any other sufficiently hard material to withstand the acoustic pressure and temperature to which the device is subjected during use. The method of operation is also shown in FIG. 3a, in which the generated ultrasound 307 is directed towards the surface 308 of the fibres resulting in more efficient drying.

Please note, that the pressurized gas can be different than the gas that contacts or surrounds the object.

FIG. 3b shows an embodiment of an ultrasound device in form of a disc-shaped jet. Shown is a preferred embodiment of an ultrasound device (301), i.e. a so-called disc jet. The device (301) comprises an annular outer part (305) and a cylindrical inner part (306), in which an annular cavity (304) is recessed. Through an annular gas passage (303) gases may be diffused to the annular opening (302) from which it may be conveyed to the cavity (304). The outer part (305) may be adjustable in relation to the inner part (306), e.g. by providing a thread or another adjusting device (not shown) in the bottom of the outer part (305), which further may comprise fastening means (not shown) for locking the outer part (305) in relation to the inner part (306), when the desired interval there between has been obtained. Such an ultrasound device may generate a frequency of about 22 kHz at a gas pressure of 4 atmospheres. The molecules of the gas are thus able to migrate up to about 33 about 22,000 times per second at a maximum velocity of 4.5 m/s. These values are merely included to give an idea of the size and proportions of the ultrasound device and by no means limit of the shown embodiment.

FIG. 3c is a sectional view along the diameter of the ultrasound device (301) in FIG. 3b illustrating the shape of the opening (302), the gas passage (303) and the cavity (304) more clearly. It is further apparent that the opening (302) is annular. The gas passage (303) and the opening (302) are defined by the substantially annular outer part (305) and the cylindrical inner part (306) arranged therein. The gas jet discharged from the opening (302) hits the substantially circumferential cavity (304) formed in the inner part (306), and then exits the ultrasound device (301). As previously mentioned the outer part (305) defines the exterior of the gas passage (303) and is further bevelled at an angle of about 30° along the outer surface of its inner circumference forming the opening of the ultrasound device, wherefrom the gas jet may expand when diffused. Jointly with a corresponding bevelling of about 60° on the inner surface of the inner circumference, the above bevelling forms an acute-angled circumferential edge defining the opening (302) externally. The inner part (306) has a bevelling of about 45° in its outer circumference facing the opening and internally defining the opening (302).

The outer part (305) may be adjusted in relation to the inner part (306), whereby the pressure of the gas jet hitting the cavity (304) may be adjusted. The top of the inner part (306), in which the cavity (304) is recessed, is also bevelled at an angle of about 45° to allow the oscillating gas jet to expand at the opening of the ultrasound device.

FIG. 3d illustrates an alternative embodiment of an ultrasound device, which is shaped as an elongated body. Shown is an ultrasound device comprising an elongated substantially rail-shaped body (301), where the body is functionally equivalent with the embodiments shown in FIGS. 3a and 3b, respectively. In this embodiment the outer part comprises two separate rail-shaped portions (305a) and (305b), which jointly with the rail-shaped inner part (306) form an ultrasound device (301). Two gas passages (303a) and (303b) are provided between the two portions (305a) and (305b) of the outer part (305) and the inner part (306). Each of said gas passages has an opening (302a), (302b), respectively, conveying emitted gas from the gas passages (303a) and (303b) to two cavities (304a), (304b) provided in the inner part (306). One advantage of this embodiment is that a rail-shaped body is able to coat a far larger surface area than a circular body. Another advantage of this embodiment is that the ultrasound device may be made in an extruding process, whereby the cost of materials is reduced.

FIG. 3e shows an ultrasound device of the same type as in FIG. 3d but shaped as a closed curve. The embodiment of the gas device shown in FIG. 3d does not have to be rectilinear. FIG. 3e shows a rail-shaped body (301) shaped as three circular, separate rings. The outer ring defines an outermost part (305a), the middle ring defines the inner part (306) and the inner ring defines an innermost outer part (305b). The three parts of the ultrasound device jointly form a cross section as shown in the embodiment in FIG. 3d, wherein two cavities (304a) and (304b) are provided in the inner part, an wherein the space between the outermost outer part (305a) and the inner part (306) defines an outer gas passage (303a) and an outer opening (302a), respectively, and the space between the inner part (306) and the innermost outer part (305b) defines an inner gas passage (304b) and an inner opening (302b), respectively. This embodiment of an ultrasound device is able to coat a very large area at a time and thus treat the surface of large objects.

FIG. 3f shows an ultrasound device of the same type as in FIG. 3d but shaped as an open curve. As shown it is also possible to form an ultrasound device of this type as an open curve. In this embodiment the functional parts correspond to those shown in FIG. 3d and other details appear from this portion of the description for which reason reference is made thereto. Likewise it is also possible to form an ultrasound device with only one opening as described in FIG. 3b. An ultrasound device shaped as an open curve is applicable where the surfaces of the treated object have unusually shapes. A system is envisaged in which a plurality of ultrasound devices shaped as different open curves are arranged in an apparatus according to the invention.

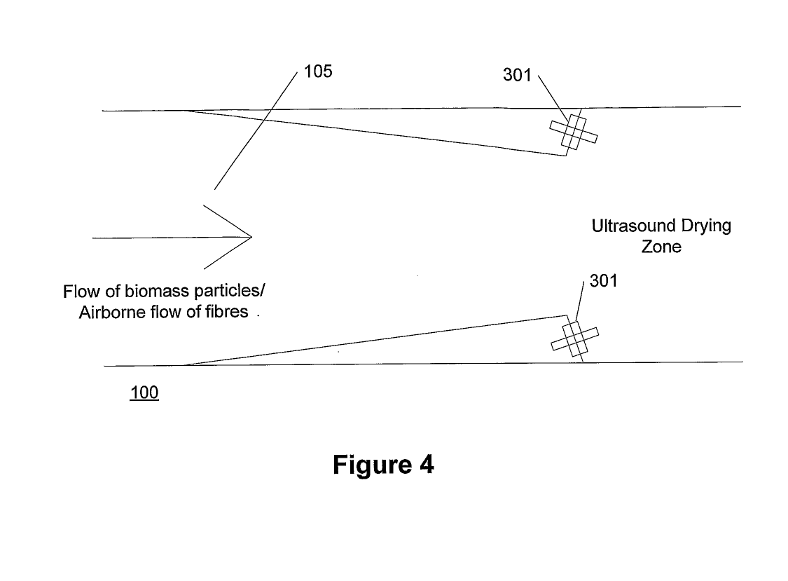

FIG. 4 schematically illustrates a part of the system where ultrasound is applied according to one embodiment of the present invention.

FIG. 4 schematically illustrates a part of the system where ultrasound is applied according to one embodiment of the present invention. Shown is a duct (100) or the like with an airborne flow of biomass particles (105). The duct (100) can e.g. be a part of a flash dryer or another type of dryer (see e.g. 101 in FIG. 1) in a dry fibreboard production line.

Within the duct (100), a number of ultrasound devices (301) are installed preferably but not exclusively as one or several rings along the walls of the duct.

In a preferred embodiment, a pressurized gas like atmospheric air or superheated steam with a pressure of about 4 atmospheres is used to activate the at least one ultrasound device.

In the shown embodiment, only a part of the volume of drying medium is used to activate the ultrasound devices, i.e. is fed through the ultrasound device whereby the drying medium also becomes the medium of the ultrasound. Using the total amount of drying gaseous medium to active the ultrasound device(s) is another alternative, i.e. substantially the entire drying medium is passed through the ultrasound devices. As another alternative, the drying medium is not used in the ultrasound device(s) but is used to dry and carry the flow of particles. However, the use of the drying medium in the ultrasound device(s) has the additional advantages that the large amount of energy typically present in such systems is utilized in generating ultrasound with a high effect and sound pressure level. Further, since the gaseous drying medium is present in traditional systems already less modifications are needed for modifying traditional system into applying the present invention.

In the claims, any reference signs placed between parentheses shall not be constructed as limiting the claim. The word “comprising” does not exclude the presence of elements or steps other than those listed in a claim. The word “a” or “an” preceding an element does not exclude the presence of a plurality of such elements.

1. A system for drying a flow of biomass particles, the system comprising:
a dryer (101) adapted to receive a flow of wet biomass particles (105) and to dry the flow of wet biomass particles (105) using a gaseous drying medium,
wherein said dryer (101) comprises at least one ultrasound device (301) or is in connection with at least one ultrasound device (301), characterized in that said at least one ultrasound device (301) is adapted, during use, to supply at least a part, of said gaseous drying medium to said flow of wet biomass particles (105) and where said at least one ultrasound device (301), during use, removes or minimizes a laminar sub-layer (313) being present at the surface of said wet biomass particles (105) and in that said at least one ultrasound device (301) is activated by at least a part of the gaseous drying medium.

2. A system according to claim 1, characterized in that said gaseous drying medium is hot air or superheated steam.

3. A system according to claim 1, characterized in that the system further comprises
binder application means (102) for applying a binder solution comprising binder droplets to the flow of biomass particles (105) wherein the binder application means (102) comprises at least one ultrasound device (301) adapted, during use, to apply ultrasound to the flow of biomass particles
before the binder solution is applied whereby particle lumps, if any, in the flow of biomass particles are separated, or
substantially at the same time that the binder solution is applied whereby particle lumps, if any, in the flow of biomass particles are separated and binder droplets are reduced to a smaller size.

4. A system according to claim 1, characterized in that the system further comprises
binder application means (102) for applying a binder solution to said flow of biomass particles (105) before they are received in said dryer (101).

5. A system according to claim 1, characterized in that said system further comprises
a forming station (103) adapted to receive a flow of biomass particles (202) applied with binder droplets (203) after application of ultrasound by said at least one ultrasound device (301) and to produce a mat from said flow of biomass particles (202) applied with binder droplets (203), and
a hot press (104) adapted to receive a mat from said forming station (103) and to produce a plate, such as a MDF (Medium Density Fibreboard) or the like, from said mat.

6. A system according to claim 1, characterized in that said ultrasound device (301) comprises:
an outer part (305) and an inner part (306) defining a passage (303),
an opening (302), and
a cavity (304) provided in the inner part (306)
where said ultrasound device (301) is adapted to receive a pressurized gas and pass the pressurized gas to said opening (302), from which the pressurized gas is discharged in a jet towards the cavity (304).

7. A system according to claim 1, characterized in that said flow of biomass particles is an airborne flow of fibres.

8. A system according to claim 1, characterized in that said flow of biomass particles is a mechanically activated flow of biomass particles usable for traditional particleboards, strands for OSB (Oriented Strand Boards) or the like.

9. A system according to claim 1, characterized in that said dryer (101) comprises a plurality of ultrasound devices (301) for supplying at least a part of said gaseous medium.

10. A system according to claim 1, characterized in that at least one of said at least one ultrasound devices (301) generates ultrasound at a sound pressure selected from the group of:
approximately 135 dB or higher,
approximately 140 dB or higher,
approximately 150 dB or higher,
approximately 160 dB or higher

11. A method of drying a flow of biomass particles, the method comprising the step of:
drying a received flow of wet biomass particles (105) using a gaseous drying medium, characterized in that said step of drying comprises
supplying at least a part of said gaseous drying medium to said flow of wet biomass particles (105) using at least one ultrasound device (301), where said at least one ultrasound device (301), during use, removes or minimizes a laminar sub-layer (313) being present at the surface of said wet biomass particles (105) and, in that said at least one ultrasound device (301) is activated by at least a part of the gaseous drying medium.

12. A method according to claim 11, characterized in that said gaseous drying medium is hot air or superheated steam.

13. A method according to claim 11, characterized in that the method further comprises the step of:
applying, by binder application means (102), a binder solution comprising binder droplets to a flow of biomass particles (105) received from a dryer (101), wherein the binder application means (102) comprises at least one ultrasound device (301) applying ultrasound, during use, to the flow of biomass particles (105)
before the binder solution is applied whereby particle lumps, if any, in the flow of biomass particles are separated, or
substantially at the same time that the binder solution is applied whereby particle lumps, if any, in the flow of biomass particles are separated and binder droplets are reduced to a smaller size.

14. A method according to claim 11, characterized in that the method further comprises
applying a binder solution to said flow of biomass particles (105) before they are received in said dryer (101).

15. A method according to claim 11, characterized in that said method further comprises
receiving a flow of biomass particles (202) applied with binder droplets (203) after application of ultrasound by said at least one ultrasound device (301) in a forming station (103) and producing a mat from said flow of biomass particles (202) applied with binder droplets (203), and
receiving a mat from said forming station (103) in a hot press (104) and producing a plate, such as a MDF (Medium Density Fibreboard) or the like, from said mat.

16. A method according to claim 11, characterized in that said ultrasound device (301) comprises:
an outer part (305) and an inner part (306) defining a passage (303),
an opening (302), and
a cavity (304) provided in the inner part (306)
where said ultrasound device (301) is adapted to receive a pressurized gas and pass the pressurized gas to said opening (302), from which the pressurized gas is discharged in a jet towards the cavity (304).

17. A method according to claim 11, characterized in that said flow of biomass particles is an airborne flow of fibres.

18. A method according to claim 11, characterized in that said flow of biomass particles is a mechanically activated flow of biomass particles usable for traditional particleboards, strands for OSB (Oriented Strand Boards) or the like.

19. A method according to claim 11, characterized in that said dryer (101) comprises a plurality of ultrasound devices (301) for supplying at least a part of said gaseous medium.

20. A method according to claim 1, characterized in that at least one of said at least one ultrasound devices (301) generates ultrasound at a sound pressure selected from the group of:
approximately 135 dB or higher,
approximately 140 dB or higher,
approximately 150 dB or higher,
approximately 160 dB or higher.
